(19) United States
(12) Patent Application Publication
(10) Pub. No.: US 2025/0322551 A1
(43) Pub. Date: Oct. 16, 2025

(54) METHOD AND APPARATUS FOR ADAPTIVE SPATIAL RESAMPLING WITH MULTI-SCALE ATTENTION TOWARDS MACHINE VISION

(71) Applicant: Alibaba (China) Co., Ltd., Hangzhou (CN)

(72) Inventors: Shurun WANG, Beijing (CN); Binzhe LI, Beijing (CN); Jie CHEN, Beijing (CN); Yan YE, San Diego, CA (US)

(21) Appl. No.: 19/091,413

(22) Filed: Mar. 26, 2025

Related U.S. Application Data
(60) Provisional application No. 63/633,318, filed on Apr. 12, 2024.

(51) Int. Cl. G06T 9/00; H04N 19/132

(52) U.S. Cl. CPC G06T 9/002; H04N 19/132

(57) ABSTRACT

A video processing method includes receiving an input picture; generating a multi-scale attention mask for the input picture; and training a resampling module using the multi-scale attention mask, wherein the trained resampling module is used to process the input picture.

### CROSS-REFERENCE TO RELATED APPLICATIONS

The disclosure claims the benefit of priority to U.S. Provisional Application No. 63/633,318, filed Apr. 12, 2024, which is incorporated herein by reference in its entirety.

### TECHNICAL FIELD

The present disclosure generally relates to video processing, and more particularly, to a method and an apparatus for adaptive spatial resampling with multi-scale attention towards machine vision.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide a video processing method. The video processing method includes receiving an input picture; generating a multi-scale attention mask for the input picture; and training a resampling module using the multi-scale attention mask, wherein the trained resampling module is used to process the input picture.

Embodiments of the present disclosure provide an apparatus for video processing. The apparatus includes a memory configured to store instructions; and one or more processors configured to execute the instructions to cause the apparatus to perform operations. The operations include receiving an input picture; generating a multi-scale attention mask for the input picture; and training a resampling module using the multi-scale attention mask, wherein the trained resampling module is used to process the input picture.

Embodiments of the present disclosure provide a non-transitory computer readable medium that stores a set of instructions that is executable by one or more processors of an apparatus to cause the apparatus to perform operations. The operations include receiving an input picture; generating a multi-scale attention mask for the input picture; and training a resampling module using the multi-scale attention mask, wherein the trained resampling module is used to process the input picture.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating an exemplary system for coding image data, according to some embodiments of the present disclosure.

FIG. 2 is a schematic diagram illustrating structures of an example video sequence, according to some embodiments of the present disclosure.

FIG. 3A is a schematic diagram illustrating an exemplary block-based encoding process, according to some embodiments of the present disclosure.

FIG. 3B is a schematic diagram illustrating another exemplary block-based encoding process, according to some embodiments of the present disclosure.

FIG. 4A is a schematic diagram illustrating an exemplary block-based decoding process, according to some embodiments of the present disclosure.

FIG. 4B is a schematic diagram illustrating another exemplary block-based decoding process, according to some embodiments of the present disclosure.

FIG. 5 is a schematic diagram illustrating an exemplary spatial resampling-based compression framework, according to some embodiments of the present disclosure.

FIG. 6 is a schematic diagram illustrating an exemplary process for multi-scale attention mask generation, according to some embodiments of the present disclosure.

FIG. 7 illustrates a flow chart showing an example method for adaptive spatial resampling with multi-scale attention towards machine vision, according to some embodiments of the present disclosure.

FIG. 8 is a diagram illustrating an exemplary optimization framework of spatial resampling with multi-scale attention, according to some embodiments of the present disclosure.

FIG. 9 illustrates a flow chart showing an example method for adaptive spatial resampling with multi-scale attention towards machine vision, according to some embodiments of the present disclosure.

FIG. 10 is a diagram illustrating an exemplary neural processing unit, according to some embodiments of the present disclosure.

FIG. 11 is a diagram illustrating an exemplary machine learning system, according to some embodiments of the present disclosure.

FIG. 12 is a block diagram of an exemplary apparatus for preprocessing or coding image data, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recently and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

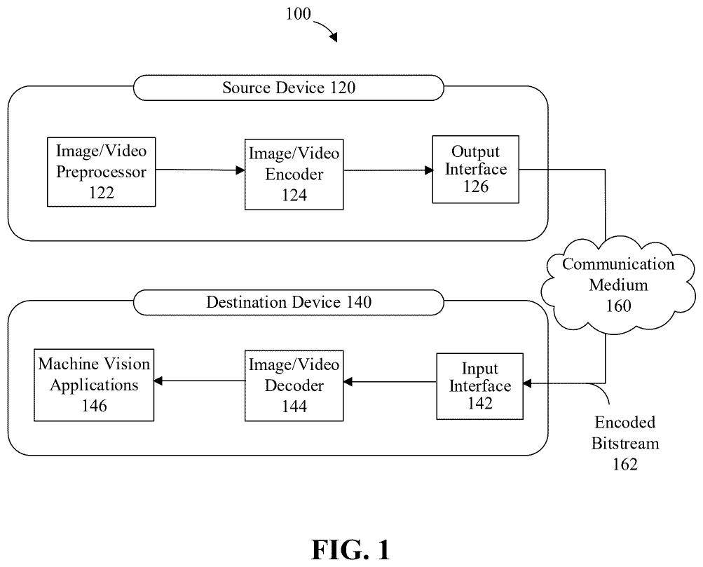

FIG. 1 is a block diagram illustrating a system 100 for coding image data, according to some disclosed embodiments. The image data may include an image (also called a “picture” or “frame”), multiple images, or a video. An image is a static picture. Multiple images may be related or unrelated, either spatially or temporary. A video is a set of images arranged in a temporal sequence.

As shown in FIG. 1, system 100 includes a source device 120 that provides encoded video data to be decoded at a later time by a destination device 140. Consistent with the disclosed embodiments, each of source device 120 and destination device 140 may include any of a wide range of devices, including a desktop computer, a notebook (e.g., laptop) computer, a server, a tablet computer, a set-top box, a mobile phone, a vehicle, a camera, an image sensor, a robot, a television, a camera, a wearable device (e.g., a smart watch or a wearable camera), a display device, a digital media player, a video gaming console, a video streaming device, or the like. Source device 120 and destination device 140 may be equipped for wireless or wired communication.

Referring to FIG. 1, source device 120 may include an image/video preprocessor 122, an image/video encoder 124, and an output interface 126. Destination device 140 may include an input interface 142, an image/video decoder 144, and machine vision applications 146. Image/video encoder 124 encodes the input bitstream and outputs an encoded bitstream 162 via output interface 126. Encoded bitstream 162 is transmitted through a communication medium 160, and received by input interface 142. Image/video decoder 144 then decodes encoded bitstream 162 to generate decoded data.

More specifically, source device 120 may further include various devices (not shown) for providing source image data to be processed by Image/video encoder 124. The devices for providing the source image data may include an image/video capture device, such as a camera, an image/video archive or storage device containing previously captured images/videos, or an image/video feed interface to receive images/videos from an image/video content provider.

Image/video encoder 124 and image/video decoder 144 each may be implemented as any of a variety of suitable encoder or decoder circuitry, such as one or more microprocessors, digital signal processors (DSPs), application specific integrated circuits (ASICs), field programmable gate arrays (FPGAs), discrete logic, software, hardware, firmware, or any combinations thereof. When the encoding or decoding is implemented partially in software, image/video encoder 124 or image/video decoder 144 may store instructions for the software in a suitable, non-transitory computer-readable medium and execute the instructions in hardware using one or more processors to perform the techniques consistent this disclosure. Each of image/video encoder 124 or image/video decoder 144 may be included in one or more encoders or decoders, either of which may be integrated as part of a combined encoder/decoder (CODEC) in a respective device.

Image/video encoder 124 and image/video decoder 144 may operate according to any video coding standard, such as Advanced Video Coding (AVC), High Efficiency Video Coding (HEVC), Versatile Video Coding (VVC), AOMedia Video 1 (AV1), Joint Photographic Experts Group (JPEG), Moving Picture Experts Group (MPEG), etc. Alternatively, image/video encoder 124 and image/video decoder 144 may be customized devices that do not comply with the existing standards. Although not shown in FIG. 1, in some embodiments, image/video encoder 124 and image/video decoder 144 may each be integrated with an audio encoder and decoder, and may include appropriate MUX-DEMUX (Multiplexer-Demultiplexer) units, or other hardware and software, to handle encoding of both audio and video in a common data stream or separate data streams.

Output interface 126 may include any type of medium or device capable of transmitting encoded bitstream 162 from source device 120 to destination device 140. For example, output interface 126 may include a transmitter or a transceiver configured to transmit encoded bitstream 162 from source device 120 directly to destination device 140 in real-time. Encoded bitstream 162 may be modulated according to a communication standard, such as a wireless communication protocol, and transmitted to destination device 140.

Communication medium 160 may include transient media, such as a wireless broadcast or wired network transmission. For example, communication medium 160 may include a radio frequency (RF) spectrum or one or more physical transmission lines (e.g., a cable). Communication medium 160 may form part of a packet-based network, such as a local area network, a wide-area network, or a global network such as the Internet. In some embodiments, communication medium 160 may include routers, switches, base stations, or any other equipment that may be useful to facilitate communication from source device 120 to destination device 140. For example, a network server (not shown) may receive encoded bitstream 162 from source device 120 and provide encoded bitstream 162 to destination device 140, e.g., via network transmission.

Communication medium 160 may also be in the form of a storage media (e.g., non-transitory storage media), such as a hard disk, flash drive, compact disc, digital video disc, Blu-ray disc, volatile or non-volatile memory, or any other suitable digital storage media for storing encoded image data. In some embodiments, a computing device of a medium production facility, such as a disc stamping facility, may receive encoded image data from source device 120 and produce a disc containing the encoded video data.

Input interface 142 may include any type of medium or device capable of receiving information from communication medium 160. The received information includes encoded bitstream 162. For example, input interface 142 may include a receiver or a transceiver configured to receive encoded bitstream 162 in real-time.

System 100 can be configured to performing video encoding and decoding based on block-based video compression techniques, deep learning based video compression techniques, talking face video compression techniques, etc.

The block-based video compression techniques use a block-based hybrid video coding framework to exploit the spatial redundancy, temporal redundancy, and information entropy redundancy in videos. This hybrid video coding framework includes motion compensation (e.g., intra/inter prediction), transform (e.g., discrete cosine transform), quantization and entropy coding. The block-based video compression techniques can be made compliant with various image/video coding standards, such as JPEG, JPEG2000, the H.264/MPEG4 part 10, Audio Video coding Standard (AVS), the H.265/HEVC standard, the Versatile Video Coding (VVC) standard, etc.

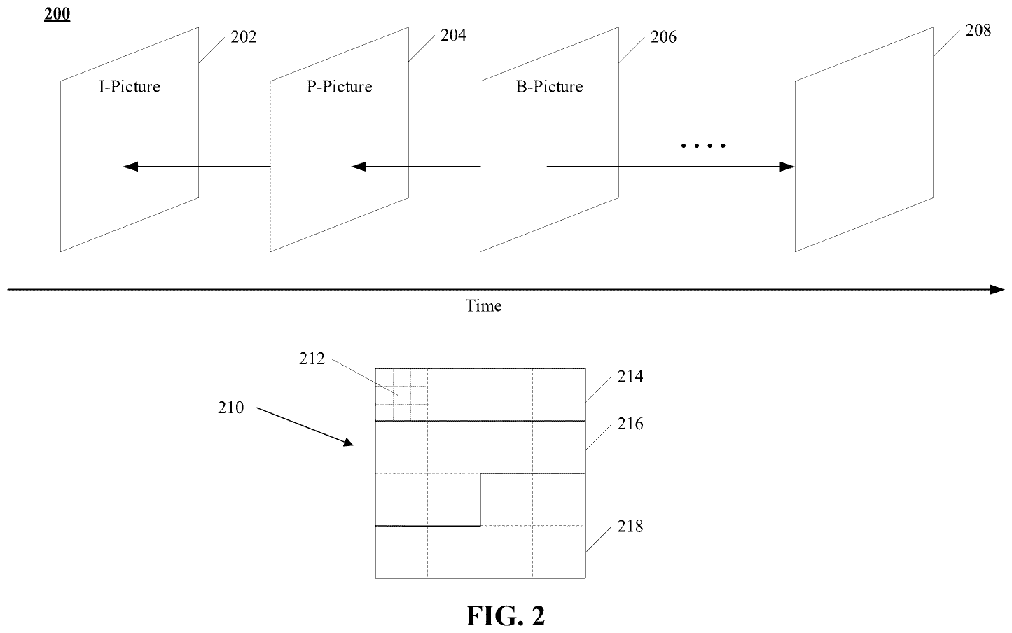

FIG. 2 illustrates structures of an example video sequence 200, according to some embodiments of the present disclosure. Video sequence 200 can be a live video or a video having been captured and archived. Video 200 can be a real-life video, a computer-generated video (e.g., computer game video), or a combination thereof (e.g., a real-life video with augmented-reality effects). Video sequence 200 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 2, video sequence 200 can include a series of pictures arranged temporally along a timeline, including pictures 202, 204, 206, and 208. Pictures 202-206 are continuous, and there are more pictures between pictures 206 and 208. In FIG. 2, picture 202 is an I-picture, the reference picture of which is picture 202 itself. Picture 204 is a P-picture, the reference picture of which is picture 202, as indicated by the arrow. Picture 206 is a B-picture, the reference pictures of which are pictures 204 and 208, as indicated by the arrows. In some embodiments, the reference picture of a picture (e.g., picture 204) can be not immediately preceding or following the picture. For example, the reference picture of picture 204 can be a picture preceding picture 202. It should be noted that the reference pictures of pictures 202-206 are only examples, and the present disclosure does not limit embodiments of the reference pictures as the examples shown in FIG. 2.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 210 in FIG. 2 shows an example structure of a picture of video sequence 200 (e.g., any of pictures 202-208). In structure 210, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC, H.266/VVC, or AVS). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

In structure 210 of FIG. 2, basic processing unit 212 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC, H.266/VVC and AVS provide two types of regions: “slices” and “tiles.” It should also be noted that different pictures of video sequence 300 can have different partition schemes for dividing a picture into regions.

For example, in FIG. 2, structure 210 is divided into three regions 214, 216, and 218, the boundaries of which are shown as solid lines inside structure 210. Region 214 includes four basic processing units. Each of regions 216 and 218 includes six basic processing units. It should be noted that the basic processing units, basic processing sub-units, and regions of structure 210 in FIG. 2 are only examples, and the present disclosure does not limit embodiments thereof.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC, H.266/VVC or AVS). Any operation performed to a basic processing unit can be repeatedly performed to each of its luma and chroma components.

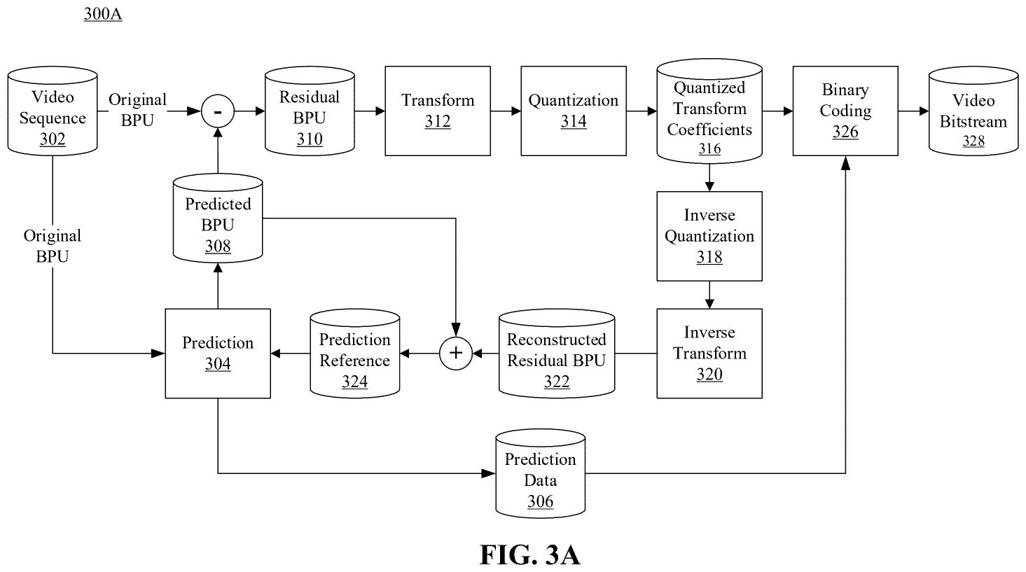

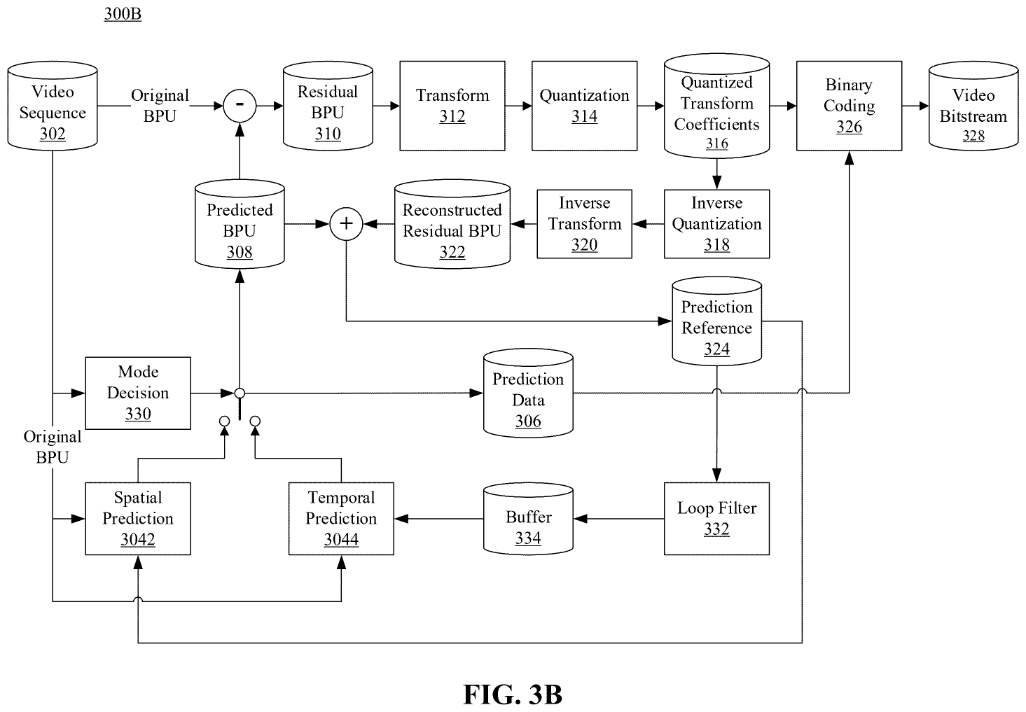

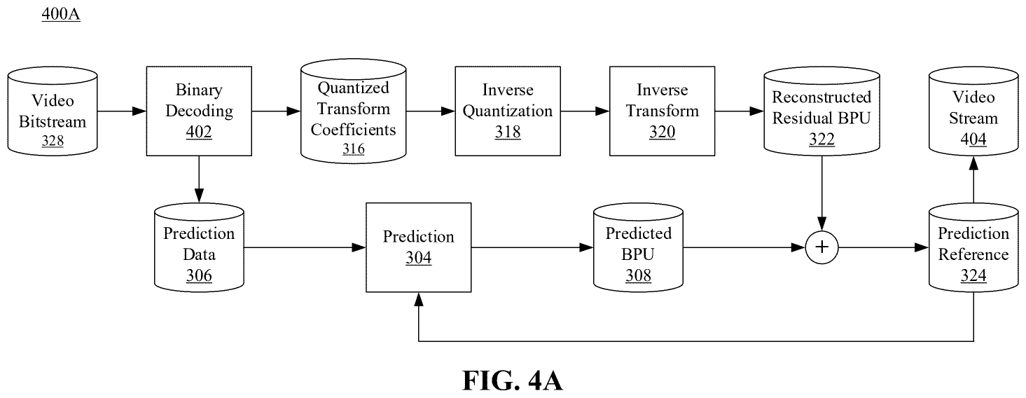

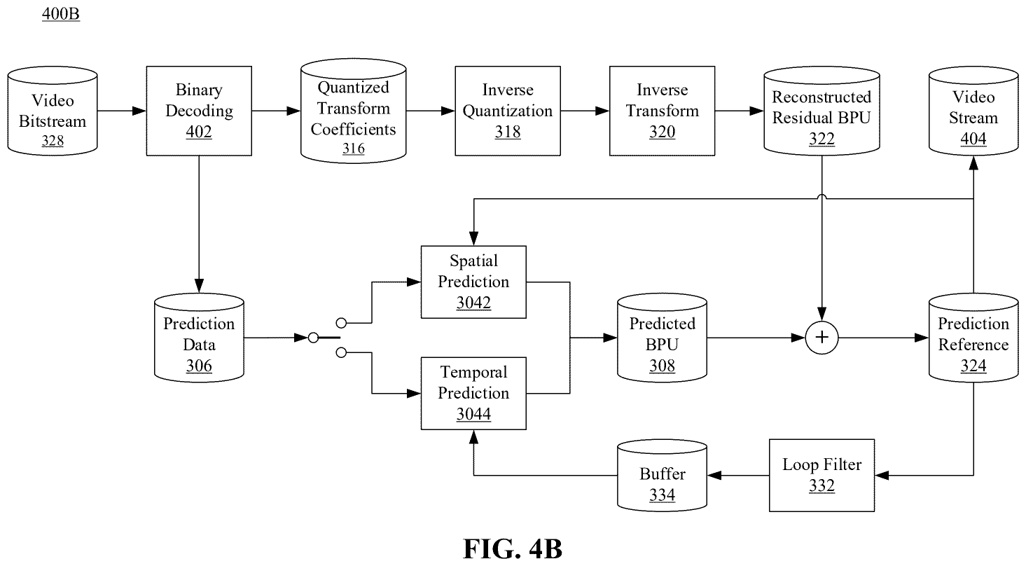

Video coding has multiple stages of operations, examples of which are shown in FIGS. 3A-3B and FIGS. 4A-4B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, H.264/AVC, or AVS), or as “coding units” (“CUs”) in some other video coding standards (e.g., H.265/HEVC, H.266/VVC, or AVS). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 3B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC, H.266/VVC, or AVS), and decide a prediction type for each individual basic processing sub-unit.

For another example, at a prediction stage (an example of which is shown in FIGS. 3A-3B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC, H.266/VVC, or AVS), at the level of which the prediction operation can be performed.

For another example, at a transform stage (an example of which is shown in FIGS. 3A-3B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC, H.266/VVC, or AVS), at the level of which the transform operation can be performed. It should be noted that the division schemes of the same basic processing sub-unit can be different at the prediction stage and the transform stage. For example, in H.265/HEVC, H.266/VVC, or AVS, the prediction blocks and transform blocks of the same CU can have different sizes and numbers.

FIG. 3A illustrates a schematic diagram of an example encoding process 300A, consistent with embodiments of the disclosure. For example, the encoding process 300A can be performed by an encoder. As shown in FIG. 3A, the encoder can encode video sequence 302 into video bitstream 328 according to process 300A. Similar to video sequence 200 in FIG. 2, video sequence 302 can include a set of pictures (referred to as “original pictures”) arranged in a temporal order. Similar to structure 210 in FIG. 2, each original picture of video sequence 302 can be divided by the encoder into basic processing units, basic processing sub-units, or regions for processing. In some embodiments, the encoder can perform process 300A at the level of basic processing units for each original picture of video sequence 302. For example, the encoder can perform process 300A in an iterative manner, in which the encoder can encode a basic processing unit in one iteration of process 300A. In some embodiments, the encoder can perform process 300A in parallel for regions (e.g., regions 214-218) of each original picture of video sequence 302.

In FIG. 3A, the encoder can feed a basic processing unit (referred to as an “original BPU”) of an original picture of video sequence 302 to prediction stage 304 to generate prediction data 306 and predicted BPU 308. The encoder can subtract predicted BPU 308 from the original BPU to generate residual BPU 310. The encoder can feed residual BPU 310 to transform stage 312 and quantization stage 314 to generate quantized transform coefficients 316. The encoder can feed prediction data 306 and quantized transform coefficients 316 to binary coding stage 326 to generate video bitstream 328. Components 302, 304, 306, 308, 310, 312, 314, 316, 326, and 328 can be referred to as a “forward path.” During process 300A, after quantization stage 314, the encoder can feed quantized transform coefficients 316 to inverse quantization stage 318 and inverse transform stage 320 to generate reconstructed residual BPU 322. The encoder can add reconstructed residual BPU 322 to predicted BPU 408 to generate prediction reference 324, which is used in prediction stage 304 for the next iteration of process 300A. Components 318, 320, 322, and 324 of process 300A can be referred to as a “reconstruction path.” The reconstruction path can be used to ensure that both the encoder and the decoder use the same reference data for prediction.

The encoder can perform process 300A iteratively to encode each original BPU of the original picture (in the forward path) and generate predicted reference 324 for encoding the next original BPU of the original picture (in the reconstruction path). After encoding all original BPUs of the original picture, the encoder can proceed to encode the next picture in video sequence 302.

Referring to process 300A, the encoder can receive video sequence 302 generated by a video capturing device (e.g., a camera). The term “receive” used herein can refer to receiving, inputting, acquiring, retrieving, obtaining, reading, accessing, or any action in any manner for inputting data.

At prediction stage 304, at a current iteration, the encoder can receive an original BPU and prediction reference 324, and perform a prediction operation to generate prediction data 306 and predicted BPU 308. Prediction reference 324 can be generated from the reconstruction path of the previous iteration of process 300A. The purpose of prediction stage 304 is to reduce information redundancy by extracting prediction data 406 that can be used to reconstruct the original BPU as predicted BPU 308 from prediction data 406 and prediction reference 324.

Ideally, predicted BPU 308 can be identical to the original BPU. However, due to non-ideal prediction and reconstruction operations, predicted BPU 308 is generally slightly different from the original BPU. For recording such differences, after generating predicted BPU 308, the encoder can subtract it from the original BPU to generate residual BPU 310. For example, the encoder can subtract values (e.g., greyscale values or RGB values) of pixels of predicted BPU 308 from values of corresponding pixels of the original BPU. Each pixel of residual BPU 310 can have a residual value as a result of such subtraction between the corresponding pixels of the original BPU and predicted BPU 308. Compared with the original BPU, prediction data 306 and residual BPU 310 can have fewer bits, but they can be used to reconstruct the original BPU without significant quality deterioration. Thus, the original BPU is compressed.

To further compress residual BPU 310, at transform stage 312, the encoder can reduce spatial redundancy of residual BPU 310 by decomposing it into a set of two-dimensional “base patterns,” each base pattern being associated with a “transform coefficient.” The base patterns can have the same size (e.g., the size of residual BPU 310). Each base pattern can represent a variation frequency (e.g., frequency of brightness variation) component of residual BPU 310. None of the base patterns can be reproduced from any combinations (e.g., linear combinations) of any other base patterns. In other words, the decomposition can decompose variations of residual BPU 310 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 312, such as, for example, a discrete cosine transform, a discrete sine transform, or the like. The transform at transform stage 312 is invertible. That is, the encoder can restore residual BPU 310 by an inverse operation of the transform (referred to as an “inverse transform”). For example, to restore a pixel of residual BPU 310, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 310 without receiving the base patterns from the encoder. Compared with residual BPU 310, the transform coefficients can have fewer bits, but they can be used to reconstruct residual BPU 310 without significant quality deterioration. Thus, residual BPU 310 is further compressed.

The encoder can further compress the transform coefficients at quantization stage 314. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 314, the encoder can generate quantized transform coefficients 316 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 316, by which the transform coefficients are further compressed. The quantization process is also invertible, in which quantized transform coefficients 316 can be reconstructed to the transform coefficients in an inverse operation of the quantization (referred to as “inverse quantization”).

Because the encoder disregards the remainders of such divisions in the rounding operation, quantization stage 314 can be lossy. Typically, quantization stage 314 can contribute the most information loss in process 300A. The larger the information loss is, the fewer bits the quantized transform coefficients 316 can need. For obtaining different levels of information loss, the encoder can use different values of the quantization parameter or any other parameter of the quantization process.

At binary coding stage 326, the encoder can encode prediction data 306 and quantized transform coefficients 316 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 306 and quantized transform coefficients 316, the encoder can encode other information at binary coding stage 326, such as, for example, a prediction mode used at prediction stage 304, parameters of the prediction operation, a transform type at transform stage 312, parameters of the quantization process (e.g., quantization parameters), an encoder control parameter (e.g., a bitrate control parameter), or the like. The encoder can use the output data of binary coding stage 326 to generate video bitstream 328. In some embodiments, video bitstream 328 can be further packetized for network transmission.

Referring to the reconstruction path of process 300A, at inverse quantization stage 318, the encoder can perform inverse quantization on quantized transform coefficients 316 to generate reconstructed transform coefficients. At inverse transform stage 320, the encoder can generate reconstructed residual BPU 322 based on the reconstructed transform coefficients. The encoder can add reconstructed residual BPU 322 to predicted BPU 308 to generate prediction reference 324 that is to be used in the next iteration of process 300A.

It should be noted that other variations of the process 300A can be used to encode video sequence 302. In some embodiments, stages of process 300A can be performed by the encoder in different orders. In some embodiments, one or more stages of process 300A can be combined into a single stage. In some embodiments, a single stage of process 300A can be divided into multiple stages. For example, transform stage 312 and quantization stage 314 can be combined into a single stage. In some embodiments, process 300A can include additional stages. In some embodiments, process 300A can omit one or more stages in FIG. 3A.

FIG. 3B illustrates a schematic diagram of another example encoding process 300B, consistent with embodiments of the disclosure. Process 300B can be modified from process 300A. For example, process 300B can be used by an encoder conforming to a hybrid video coding standard (e.g., H.26x series). Compared with process 300A, the forward path of process 300B additionally includes mode decision stage 330 and divides prediction stage 304 into spatial prediction stage 3042 and temporal prediction stage 3044. The reconstruction path of process 300B additionally includes loop filter stage 332 and buffer 334.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 324 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 324 in the temporal prediction can include the coded pictures. The temporal prediction can reduce the inherent temporal redundancy of the pictures.

Referring to process 300B, in the forward path, the encoder performs the prediction operation at spatial prediction stage 3042 and temporal prediction stage 3044. For example, at spatial prediction stage 3042, the encoder can perform the intra prediction. For an original BPU of a picture being encoded, prediction reference 324 can include one or more neighboring BPUs that have been encoded (in the forward path) and reconstructed (in the reconstructed path) in the same picture. The encoder can generate predicted BPU 308 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 308. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 306 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 3044, the encoder can perform the inter prediction. For an original BPU of a current picture, prediction reference 324 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 322 to predicted BPU 308 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 2), it can be deemed that the matching region “moves” to the location of the original BPU as time goes by. The encoder can record the direction and distance of such a motion as a “motion vector.” When multiple reference pictures are used (e.g., as picture 206 in FIG. 2), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 406 can include, for example, locations (e.g., coordinates) of the matching region, the motion vectors associated with the matching region, the number of reference pictures, weights associated with the reference pictures, or the like.

For generating predicted BPU 308, the encoder can perform an operation of “motion compensation.” The motion compensation can be used to reconstruct predicted BPU 308 based on prediction data 306 (e.g., the motion vector) and prediction reference 324. For example, the encoder can move the matching region of the reference picture according to the motion vector, in which the encoder can predict the original BPU of the current picture. When multiple reference pictures are used (e.g., as picture 206 in FIG. 2), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 204 in FIG. 2 is a unidirectional inter-predicted picture, in which the reference picture (e.g., picture 202) precedes picture 204. Bidirectional inter predictions can use one or more reference pictures at both temporal directions with respect to the current picture. For example, picture 206 in FIG. 2 is a bidirectional inter-predicted picture, in which the reference pictures (e.g., pictures 204 and 208) are at both temporal directions with respect to picture 204.

Still referring to the forward path of process 300B, after spatial prediction 3042 and temporal prediction stage 3044, at mode decision stage 330, the encoder can select a prediction mode (e.g., one of the intra prediction or the inter prediction) for the current iteration of process 300B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 308 and predicted data 306.

In the reconstruction path of process 300B, if intra prediction mode has been selected in the forward path, after generating prediction reference 324 (e.g., the current BPU that has been encoded and reconstructed in the current picture), the encoder can directly feed prediction reference 324 to spatial prediction stage 3042 for later usage (e.g., for extrapolation of a next BPU of the current picture). The encoder can feed prediction reference 324 to loop filter stage 332, at which the encoder can apply a loop filter to prediction reference 324 to reduce or eliminate distortion (e.g., blocking artifacts) introduced during coding of the prediction reference 324. The encoder can apply various loop filter techniques at loop filter stage 332, such as, for example, deblocking, sample adaptive offsets, adaptive loop filters, or the like. The loop-filtered reference picture can be stored in buffer 334 (or “decoded picture buffer”) for later use (e.g., to be used as an inter-prediction reference picture for a future picture of video sequence 302). The encoder can store one or more reference pictures in buffer 334 to be used at temporal prediction stage 3044. In some embodiments, the encoder can encode parameters of the loop filter (e.g., a loop filter strength) at binary coding stage 326, along with quantized transform coefficients 316, prediction data 306, and other information.

FIG. 4A illustrates a schematic diagram of an example decoding process 400A, consistent with embodiments of the disclosure. Process 400A can be a decompression process corresponding to the compression process 300A in FIG. 3A. In some embodiments, process 400A can be similar to the reconstruction path of process 300A. A decoder can decode video bitstream 328 into video stream 404 according to process 400A. Video stream 404 can be very similar to video sequence 302. However, due to the information loss in the compression and decompression process (e.g., quantization stage 314 in FIGS. 3A-3B), generally, video stream 404 is not identical to video sequence 302. Similar to processes 300A and 300B in FIGS. 3A-3B, the decoder can perform process 400A at the level of basic processing units (BPUs) for each picture encoded in video bitstream 428. For example, the decoder can perform process 400A in an iterative manner, in which the decoder can decode a basic processing unit in one iteration of process 400A. In some embodiments, the decoder can perform process 400A in parallel for regions (e.g., regions 214-218) of each picture encoded in video bitstream 328.

In FIG. 4A, the decoder can feed a portion of video bitstream 328 associated with a basic processing unit (referred to as an “encoded BPU”) of an encoded picture to binary decoding stage 402. At binary decoding stage 402, the decoder can decode the portion into prediction data 306 and quantized transform coefficients 316. The decoder can feed quantized transform coefficients 316 to inverse quantization stage 318 and inverse transform stage 320 to generate reconstructed residual BPU 322. The decoder can feed prediction data 306 to prediction stage 304 to generate predicted BPU 308. The decoder can add reconstructed residual BPU 322 to predicted BPU 308 to generate predicted reference 324. In some embodiments, predicted reference 324 can be stored in a buffer (e.g., a decoded picture buffer in a computer memory). The decoder can feed predicted reference 324 to prediction stage 304 for performing a prediction operation in the next iteration of process 400A.

The decoder can perform process 400A iteratively to decode each encoded BPU of the encoded picture and generate predicted reference 324 for encoding the next encoded BPU of the encoded picture. After decoding all encoded BPUs of the encoded picture, the decoder can output the picture to video stream 404 for display and proceed to decode the next encoded picture in video bitstream 328.

At binary decoding stage 402, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 306 and quantized transform coefficients 316, the decoder can decode other information at binary decoding stage 402, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 328 is transmitted over a network in packets, the decoder can depacketize video bitstream 328 before feeding it to binary decoding stage 402.

FIG. 4B illustrates a schematic diagram of another example decoding process 400B, consistent with embodiments of the disclosure. Process 400B can be modified from process 400A. For example, process 400B can be used by a decoder conforming to a hybrid video coding standard (e.g., H.26x series). Compared with process 400A, process 400B additionally divides prediction stage 304 into spatial prediction stage 3042 and temporal prediction stage 3044, and additionally includes loop filter stage 332 and buffer 334.

In process 400B, for an encoded basic processing unit (referred to as a “current BPU”) of an encoded picture (referred to as a “current picture”) that is being decoded, prediction data 306 decoded from binary decoding stage 402 by the decoder can include various types of data, depending on what prediction mode was used to encode the current BPU by the encoder. For example, if intra prediction was used by the encoder to encode the current BPU, prediction data 306 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 306 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 3042 or a temporal prediction (e.g., the inter prediction) at temporal prediction stage 3044. The details of performing such spatial prediction or temporal prediction are described in FIG. 3B and will not be repeated hereinafter. After performing such spatial prediction or temporal prediction, the decoder can generate predicted BPU 308. The decoder can add predicted BPU 308 and reconstructed residual BPU 322 to generate prediction reference 324, as described in FIG. 4A.

In process 400B, the decoder can feed predicted reference 324 to spatial prediction stage 3042 or temporal prediction stage 3044 for performing a prediction operation in the next iteration of process 400B. For example, if the current BPU is decoded using the intra prediction at spatial prediction stage 3042, after generating prediction reference 324 (e.g., the decoded current BPU), the decoder can directly feed prediction reference 324 to spatial prediction stage 3042 for later usage (e.g., for extrapolation of a next BPU of the current picture). If the current BPU is decoded using the inter prediction at temporal prediction stage 3044, after generating prediction reference 324 (e.g., a reference picture in which all BPUs have been decoded), the decoder can feed prediction reference 324 to loop filter stage 332 to reduce or eliminate distortion (e.g., blocking artifacts). The decoder can apply a loop filter to prediction reference 324, in a way as described in FIG. 3B. The loop-filtered reference picture can be stored in buffer 334 (e.g., a decoded picture buffer in a computer memory) for later use (e.g., to be used as an inter-prediction reference picture for a future encoded picture of video bitstream 328). The decoder can store one or more reference pictures in buffer 334 to be used at temporal prediction stage 3044. In some embodiments, prediction data can further include parameters of the loop filter (e.g., a loop filter strength). In some embodiments, prediction data includes parameters of the loop filter when the prediction mode indicator of prediction data 306 indicates that inter prediction was used to encode the current BPU.

To further improve the coding performance, numerous algorithms have been developed for future video compression standards, including matrix weighted intra prediction, quadtree plus binary tree, extended coding unit partitioning, affine motion prediction, decoder-side motion vector refinement and mode-dependent non-separable secondary transform. Regarding encoder optimization, various optimization algorithms have also been developed for different targets, including rate-distortion optimization for both signal and feature quality. For surveillance video data, which has been regarded as the largest big data, the concept of golden frames has been introduced for providing better reference quality, and based on this philosophy, background modeling-based surveillance video compression techniques have been developed. Moreover, along with the development of cloud computing, a cloud database has been introduced in image compression as an external reference to further remove the redundancy. In addition, efforts have been devoted to analyzing the bitstream without complete decoding due to the abundant information implied in the bitstream. Scalable compression has become more important in various applications, such as video streaming. Scalable extensions have been proposed for various compression standards, including the scalable extension to H.264/MPEG-4 part 10 AVC (H.264/AVC) and the scalable extension of H.265/HEVC, which are denoted as scalable video coding (SVC) and scalable high-efficiency video coding (SHVC), respectively. The scalable extensions support video scalability in terms of temporal resolution, spatial resolution and quality. Moreover, SHVC supports the scalability of the bit depth and color gamut to fit the deployment of ultrahigh-definition (UHD) video.

Traditional hybrid codecs have been pivotal in the proliferation of digital video, addressing the dual challenges of limited bandwidth and storage with remarkable efficiency.

The development of deep learning-based video compression is a rapidly advancing area of research that seeks to leverage the powerful capabilities of neural networks to revolutionize the way video is compressed and decompressed. Traditional video compression techniques, based on handcrafted algorithms and standards, have been highly successful but are reaching the limits of their efficiency, especially with the ever-increasing video resolutions and frame rates. Deep learning-based methods offer a new avenue for gains in compression by learning optimal representations and compression strategies directly from the data.

The initial foray into deep learning-based video compression began as an exploration of how machine learning, particularly neural networks, could be applied to improve upon the limitations of traditional codec architectures. Researchers started experimenting with various components of the video compression pipeline, seeking to understand where neural networks could fit and how they could enhance the overall process. The first experiments in this domain involved replacing specific components of existing codecs with neural network-based alternatives. For instance, one of the earliest applications was in predictive coding, where neural networks were trained to predict pixel values more accurately than traditional linear models. Another area of exploration was the use of neural networks for improved motion estimation and compensation, which are central to inter-frame compression in traditional codecs. Developers of deep learning-based codecs also focused on intra-frame compression. Convolutional neural networks (CNNs) were particularly suited for this task due to their ability to capture spatial hierarchies in image data. CNNs were trained to transform an image into a compact set of feature maps, which were then quantized and entropy-coded, similar to the process in traditional codecs. However, unlike handcrafted transformations such as discrete cosine transform (DCT), the neural networks could learn transformations that were specifically tailored to the characteristics of the video content. Entropy coding also attracts the interest from both academia and industry, which is a lossless compression step that aims to minimize the number of bits needed to represent the data. Researchers started to explore how neural networks could optimize entropy coding by learning the probability distributions of the data more effectively. Techniques such as autoencoders and recurrent neural networks (RNNs) were utilized to model and encode the data in a more compact form than traditional entropy coding methods like Huffman coding or arithmetic coding. With the advent of deep learning, the idea of in-loop filtering has been reimagined, leading to the development of deep learning-based in-loop filters that can learn to perform this task more effectively. Neural networks are trained to reduce artifacts such as blocking, banding, and blurring that arise due to quantization and other lossy compression processes. Unlike static filters, deep learning-based filters can adapt to the content and characteristics of the video, potentially offering improved reconstruction quality and compression efficiency.

Except for the integrations of deep learning techniques within the traditional hybrid video codecs, the video compression efficiency is further explored in terms of the deep learning based end-to-end structure and optimization. End-to-end learning for video compression represents an innovative approach where the entire compression pipeline is conceptualized, designed, and optimized as a complete system using deep learning techniques. This holistic perspective contrasts with traditional methods, which are composed of distinct modules, each engineered to perform specific tasks like motion estimation, transformation, or entropy coding. With end-to-end learning, neural networks are trained to handle all these functions in a unified framework, potentially discovering more efficient and effective strategies for video compression through direct optimization of a loss function that captures the desired trade-off between compression rate and video quality.

A vanguard work that applied a recurrent neural network (RNN) to end-to-end learned image representation achieves comparable performance compared with JPEG. Dong et al. proposed a block transform-based image compression model that outperforms JPEG at low bit rates based on the combination of discrete cosine transform (DCT) and convolutional neural network (CNN) models. Generalized divisive normalization (GDN)-based image coding was proposed with a density estimation model and achieves obvious compression performance promotion compared with JPEG 2000. Based on this method, the redundancy is further eliminated with a variational hyperprior model, which surpasses Better Portable Graphics (BPG) in terms of rate-distortion performance. The deep video compression (DVC) approach based on an end-to-end model has also achieved better performance compared with H.264/AVC. Generally speaking, the deep learning image compression (DLIC) optimizes the parameters of the encoder and decoder with specific rate-distortion (R-D) tradeoff. In order to explore the generalization of DLIC across various R-D tradeoffs and reduce the memory requirement of storing model parameters, various methods have been proposed for the variable bitrate DLIC. Specifically, a conditional autoencoder was designed in terms of Lagrange multiplier and quantization bin size. A gain unit was proposed to achieve a continuously variable rate in a single model. A channel-wise attention module was introduced to further exploit the bitrate variability. Moreover, a learned variable-rate multi-frequency image compression algorithm was presented, based on the proposed modulated generalized octave convolution (GoConv) and octave transposed-convolution (GoTConv). The proposed scheme can achieve similar performance with HEVC in terms of YUV PSNR (Peak Singal-to-Noise Ratio) and obvious improvement compared with VVC in terms of Y MS-SSIM (Multi-Scale Structural Similarity Index), in large bitrate range with only three models. The variable-rate video compression scheme was also proposed with a deeply modulated auto-encoder, achieving continuous variable bitrate with almost same compression efficiency as multiple fixed-rate models.

Video coding for machine vision refers to the optimization of video compression techniques specifically for consumption by machine vision systems rather than human viewers. Machine vision systems are used in a variety of applications such as autonomous vehicles, robotics, industrial automation, and surveillance, where it is crucial for the algorithm to detect, classify, and make decisions based on video input. The requirements of machine vision systems can be quite different from those of human viewers, which has led to the development of specialized video coding techniques to meet these unique needs. video coding for machine vision seeks to modify and optimize traditional video compression techniques to suit the needs of automated analysis systems. The focus is on preserving the features that are important for machine interpretation, maintaining low latency, ensuring robustness against environmental conditions, and achieving efficient compression to reduce storage and bandwidth usage.

There are various algorithms proposed to improve the compression efficiency of VCM, which mainly focus on the core component of codec (denoted as core codec), i.e., transforming the visual signal to the bitstream. Generally speaking, the core codec can be classified into the codec with hybrid coding framework and the deep learning-based codec, which have been investigated for machine vision in recent years. In hybrid coding framework for image codec, the quantization model can be improved in terms of rate-accuracy performance. Similarly, various algorithms have been proposed to improve machine vision oriented compression performance of video codecs from the perspective of QP decision model for HEVC and VVC. Moreover, a bitwise efficiency method was proposed in to improve the coding performance of VSCM by truncating the bit depth of luma sample values, motivated by the low sensitivity of bit depth for machine vision tasks.

For deep learning-based codec, the machine vision task losses, image distortion losses and rate loss are combined for the optimization of end-to-end compression model, which outperforms VVC significantly on object detection and instance segmentation tasks. Based on this, the compression performance is improved by optimizing the encoder of the pre-trained codec with online fine-tuning. A latent space masking network (LSMnet) was proposed to mask out the latent space elements, which are presumably not important for instance segmentation task. The redundancy is reduced with a saliency-driven hierarchical neural network image compression model, and the saliency information is extracted with an object detection network. Moreover, an end-to-end image compression is designed for multiple machine tasks. to enable the transformation of the compressed content, from the primary task (object detection) to the secondary task (classification). Motivated by the representation capability of deep learning features for machine analysis, a learning-based codec was proposed, which can compress the extracted machine analysis features and reconstruct the visual signal from the decoded analysis feature. The distortion of joint loss functions for learning based compression models mainly consists of two parts, the signal level fidelity and the machine vision losses, where the weight between the two parts are set empirically, limiting the compression efficiency. To tackle this problem, a general rate-accuracy optimization algorithm was proposed, achieving superior performance than various empirical settings. The joint optimization of the end-to-end compression model and the task model was investigated, achieving superior object detection performance than the Human Visual System (HVS) oriented end-to-end compression model. Moreover, a unified optimization framework was proposed with variable bitrate modules for both codec and machine analysis model. The machine vision-oriented learning-based video compression is also investigated. An end-to-end video compression framework was developed with a combination of variable-rate intra coding and scale space flow based inter coding. Learned image codec was proposed for intra frame coding and combined with VVC for inter frame coding, denoted as NNVVC (Neural Network VVC). Compared with VVC, NNVVC achieves 51.76% and 38.07% BD-rate (Bjontegaard-Delta rate) savings for instance segmentation task on Open Images dataset and Tencent Video Dataset (TVD) dataset, respectively.

Spatial resampling is an important solution to improve video compression efficiency, motivated by the high spatial redundancy of video data. For spatial resampling towards human vision, a down-sampling-based framework was proposed for image compression performance improvement at low bitrates. In order to preserve the high-frequency information degradation caused by spatial resampling, the local random convolution kernel was further proposed. Regarding spatial resampling for machine vision, a spatial resampling model was proposed and optimized with a joint loss function, which is composed signal-level distortion and machine vision loss function. Moreover, a simulation codec was developed for the joint optimization of spatial down-sampling and up-sampling with codec. However, the spatial complexity of various videos could be diverse, indicating that spatial resampling should be performed adaptively considering the video contents diversity across various regions.

Moreover, current spatial resampling methods towards machine vision focus on the down-sampling before encoding and the up-sampling after decoding, which could save the coding bits for encoding and recover the reconstruction after decoding, respectively. This pipeline is suitable for videos with large resolutions. However, for videos with small resolution, in terms of machine vision applications, up-sampling before encoding or after decoding have not been considered, which could preserve the information before encoding, and enhance the reconstruction quality after decoding respectively.

Furthermore, targeting for videos with large and small resolutions have not been fully considered in current spatial resampling.

On the one hand, for videos with large resolution, the discrimination diversity of various object contents with multiple scales during down-sampling and up-sampling. Specifically, for videos with large resolution, down-sampling then up-sampling pipeline is generally adopted. Current algorithms mainly focus on better down-sampling before encoding and better up-sampling after decoding, weighting every region equally without considering the diversity across spatial regions. For example, for a specific video frame, there are two objects with dramatic different sizes, i.e., large one and small one. Considering object detection task, the discrimination of small object would be degraded significantly with down-sampling. However, the large object would be detected more easily under the same down-sampling. The discrimination differences towards machine have not been considered and investigated in terms of spatial resampling.

On the other hand, for videos with small resolution, the spatial up-sampling only method is applied for machine vision. Specifically, for videos with small resolution, in terms of machine vision, there are alternative ways with up-sampling only methods, compared with general down-up sampling pipeline. For example, a two up-sampling based method, e.g., up-sampling the original video before encoding to preserve more information and up-sampling the reconstructed video after decoding to enhance the reconstruction quality, has not been considered.

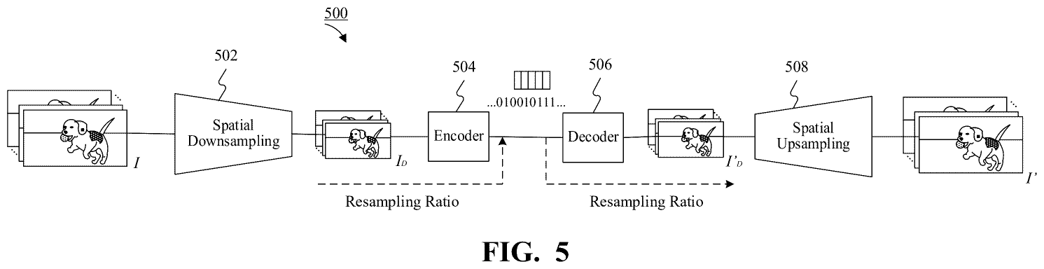

FIG. 5 is a schematic diagram illustrating an exemplary spatial resampling-based compression framework, according to some embodiments of the present disclosure. The spatial resampling-based compression framework 500 can be used in machine vision oriented spatial resampling algorithms. As shown in FIG. 5, before encoding, the input video data/is rescaled with a spatial down-sampling model 502. The down-sampled data I_{D} is the output after the spatial down-sampling 502 and then compressed with the encoder 504. After decoding, the decompressed down-sampled data I_{D}′ is obtained after the decoder 506. The reconstructed video data l′ is the output after the spatial up-sampling 508, based on the resampling ratio transmitted along with the bitstream. Since the spatial complexity of videos can be different, the same spatial resampling technique for various videos could limit the robustness and performance improvement. Therefore, an adaptive spatial resampling is in needed.

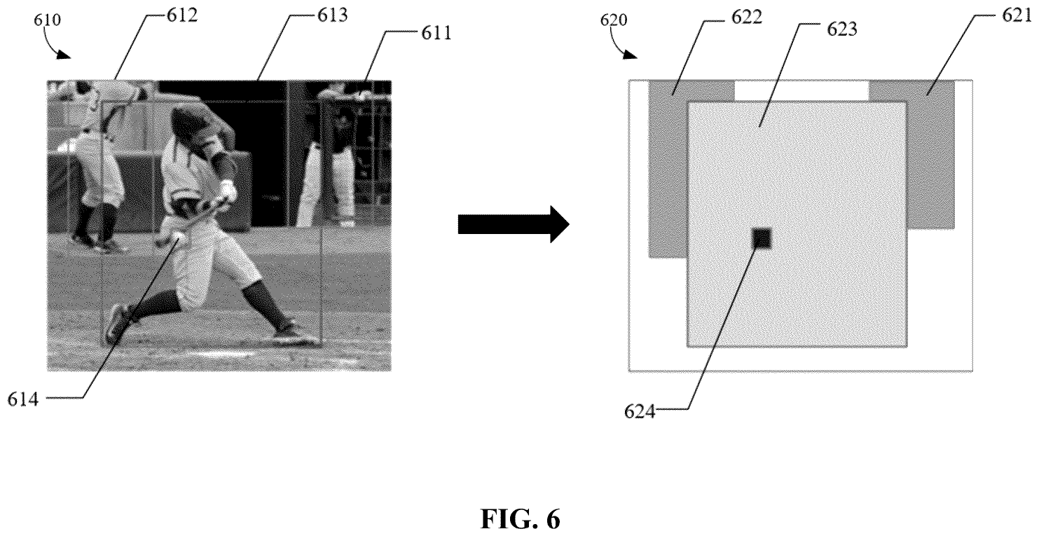

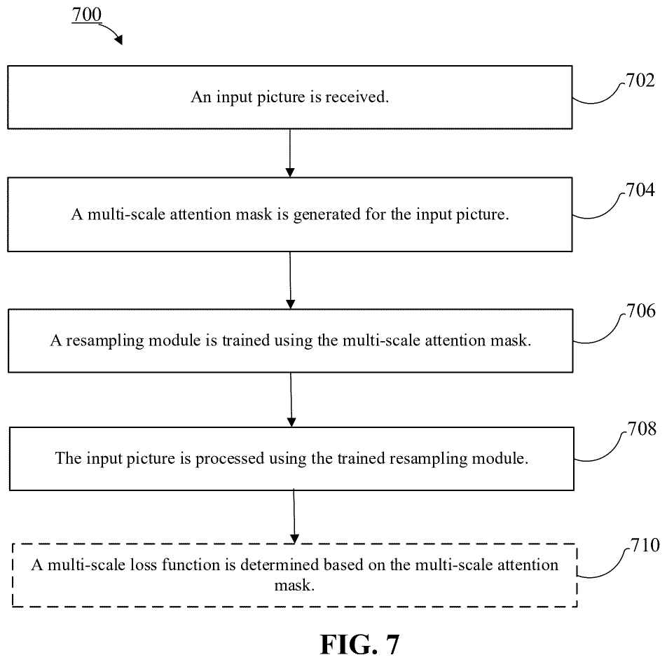

Considering the discrimination diversity of various object contents with multiple scales, embodiments of the present disclosure provide a method for adaptive spatial resampling with multi-scale attention towards machine vision. FIG. 6 is a schematic diagram illustrating an exemplary process for multi-scale attention mask generation, according to some embodiments of the present disclosure. FIG. 7 illustrates a flow chart showing an example method for adaptive spatial resampling with multi-scale attention towards machine vision, according to some embodiments of the present disclosure. Referring to FIG. 6 and FIG. 7, a multi-scale attention resampling model is proposed. For example, method 700 can be performed or implemented by software stored in a machine learning device or system. Referring to FIG. 7, method 700 may include the following steps 702 to 708.

At step 702, an input picture is received. The input picture can be one picture/frame of a video sequence.

At step 704, a multi-scale attention mask is generated for the input picture. The multi-scale attention mask may represent different spatial importance weights corresponding to the blocks in the input picture. The multi-scale attention mask may have the same resolution as the input picture. In some embodiments, one or more objects are detected in the input picture. For example, referring to FIG. 6, four objects 611-614 are detected in an input picture 610, where the baseball (e.g., detected object 614) is small, two persons (e.g., detected objects 611 and 612) are in middle size, and the person (e.g., detected object 613) in the middle is the largest. It's obvious that the discrimination of the small object, e.g., detected object 614, would be severely degraded after down-sampling, while the impact of down-sampling for large object (e.g., detected object 613) is small. Importance weights can be considered for different objects in one picture for training a resampling module. The importance weights can be determined based on sizes of the corresponding detected objects. For example, for a small detected object in the input picture, the importance weight is large, and the value of the corresponding region of the mask is large. A value in the mask represents an importance weight in the picture. In some embodiments, the values in the mask are in a range from 0 to 1. For example, if an area of the detected object is smaller than 32×32, the value is 0.75; if the area of the detected object is in a range from 32×32 to 96×96, the value is 0.5; and if the area of the detected object is larger than 96×96, the value is 0.25, where the area is in pixels. It can be understood that alternative ways can also be used to generate the mask values, as long as the smaller object is, the corresponding value in the mask is larger. In some embodiments, the values in the mask could be inferred based on the areas of the detected objects. For example, the value in the mask for a specific object region can be determined with following formula:

$$v = 1 - 2 ( \frac{1}{1 + {e}^{\frac{a}{h w}}} - 0.5 ) ,$$

where a is an area of the detected object, h and w are the height and width of the input picture. Referring to FIG. 6, a multi-scale attention mask 620 is generated for input picture 610. The blocks having darker color in the mask 620 corresponds to larger values. For example, the value in block 624, which corresponds to the detected object 614, is larger than a value in block 622 which corresponding to the detected object 612, and the value in block 622 is larger than a value in block 623 which corresponding to the detected object 613. Therefore, a multi-scale attention mask includes a set of values represent different importance weights of detected objects in the picture.

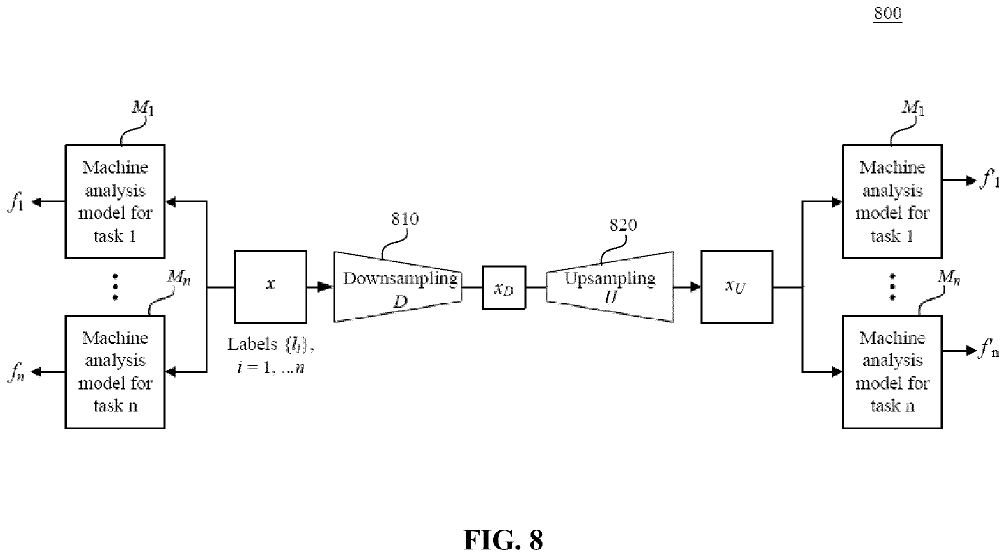

At step 706, a resampling module is trained using the multi-scale attention mask. The resampling module may include a down-sampling module and an up-sampling module. The down-sampling module and the up-sampling module can be one or more processors. The down-sampling and up-sampling may have the same resampling ratio. FIG. 8 is a diagram illustrating an exemplary optimization framework of spatial resampling with multi-scale attention, according to some embodiments of the present disclosure. Referring to FIG. 8, spatial resampling framework 800 for optimization mainly includes a down-sampling module 810 and an up-sampling module 820. The compression codec is not involved due to the non-differentiability of visual data codecs. Specifically, an input image x is fed into the down-sampling module 810 to achieve a compact image representation x_{D}. The up-sampling module 820 takes the compact image representation x_{D} as an input to recover the machine analysis information, and the output is x_{U}. Moreover, {fᵢ} and {f′ᵢ} are the extracted feature maps of pretrained machine analysis model Mᵢ from the input image x and the up-sampled image x_{U} respectively. The multi-scale attention mask having a set of values can be used to train the down-sampling module 810 and the up-sampling module 820.

At step 708, the input picture is processed using the trained resampling module. For example, the input picture can be processed using a spatial resampling-based compression framework (e.g., framework 500 shown in FIG. 5). Specifically, the input picture is down-sampled using the trained down-sampling module to obtain a down-sampled picture. Then the down-sampled picture is encoded and decoded by a codec (e.g., encoder 124 or decoder 144 shown in FIG. 1) to obtain a reconstructed picture. Finally, the reconstructed picture is up-sampled using the trained up-sampling module to obtain an output picture.

In some embodiments, method 700 further includes step 710 to determine a multi-scale loss function. At step 710, a multi-scale loss function is determined based on the multi-scale attention mask. In consistent with FIG. 8, a multi-scale attention loss function is formulated as below:

$$L ( x , {x}_{U} , {M}_{s} ) = {‖ {x}_{U} - x ‖}_{2}^{2} + {‖ {M}_{s} ( {x}_{U} - x ) ‖}_{2}^{2} + {Σ}_{i}^{n} {w}_{f , i} ( {L}_{f , i} ( x , {x}_{U} , {w}_{f , i} ) + {L}_{f , i , {M}_{s}} ( x , {x}_{U} , {M}_{s} , {w}_{f , i} ) ) ,$$

where, Mₛ is the multi-scale attention mask, {w_{f,i}} are the weights of feature map distortion from various machine analysis models, x represents the input picture, and x_{U} represents an output picture after resampling. Moreover,

$${L}_{f , i} ( x , {x}_{U} , {w}_{f , i} ) = {\sum }_{j = 1}^{m} {w}_{f , i , j} {‖ {f}_{i , j} - {f}_{i , j}^{′} ‖}_{2}^{2}$$

calculates the weighted feature map distortion, without considering the multi-scale objects. Similarly,

$${L}_{f , i , {M}_{s}} ( x , {x}_{U} , {M}_{s} , {w}_{f , i} ) = {\sum }_{j = 1}^{m} {w}_{f , i , j} {‖ {M}_{s , j} ( {f}_{i , j} - {f}_{i , j}^{′} ) ‖}_{2}^{2}$$

distortion with multi-scale attention, where M_{s,j} indicates the resized mask according to the resolution of f_{i,j}, and {w_{f,i,j}} are the weights for various feature map distortions for {fᵢ} and {f′ᵢ}. The training process can be evaluated and adjusted based on the multi-scale loss, therefore, an optimized resampling module can be further obtained.

Embodiments of the present disclosure also provide a method of spatial up-sampling to improve the coding performance for low resolution videos.

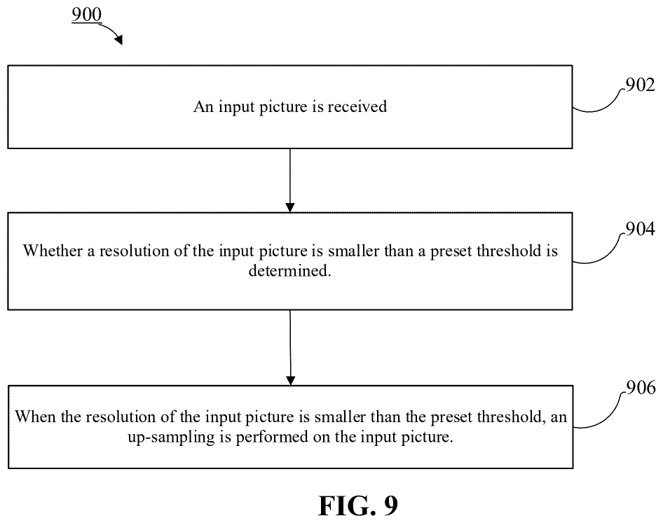

FIG. 9 illustrates a flow chart showing an example method of spatial up-sampling towards machine vision, according to some embodiments of the present disclosure. Method 900 can be performed by one or more software or hardware components of an apparatus. In some embodiments, method 900 can be performed by one or more processors. For example, the processor may include any combination of any number of a central processing unit (or “CPU”), a graphics processing unit (or “GPU”), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), a neural processing unit (NPU), and any type of circuit capable of data processing. In some embodiments, the accelerator can include the GPU, the NPU, among other types. In some embodiments, method 900 can be implemented by a computer program product, embodied in a computer-readable medium, including computer-executable instructions, such as program code, executed by computers. As shown in FIG. 9, method 900 includes steps 902 to 906.

At step 902, an input picture is received. The input picture can be one picture/frame of a video sequence.

At step 904, whether a resolution of the input picture is smaller than a preset threshold is determined. For example, the preset threshold can be set according to a performance of an apparatus for processing the input picture. In some embodiments, the preset threshold can be set according to a quality requirement of the processing. In some embodiments, the preset threshold can be set as, for example, 832×960.

At step 906, when the resolution of the input picture is smaller than the preset threshold, an up-sampling is performed on the input picture and there is no down-sampling performed in this case. Therefore, a low resolution picture, only up-sampling is performed to preserve more information or enhance the quality. In some embodiments, a resampling ratio can be further determined based on the resolution of the input picture.

For example, if the resolution of input video/picture is 416×240, a 2× spatial up-sampling could be applied, i.e., a resampling ratio is 2; and if the resolution of input video/picture is 832×480, a 1.5× spatial up-sampling could be applied, i.e., a resampling ratio is 1.5. In some embodiments, the up-sampling is performed on the input picture before encoding, so that more information of input pictures can be saved for future processing. In some embodiments, the up-sampling is performed on a reconstructed picture of the input picture after decoding, thereby enhancing the reconstruction quality. Various up-sampling techniques can be used for the up-sampling, such as Bicubic interpolation, Lanczos interpolation and deep learning based up-sampling models.

The embodiments described in the present disclosure can be freely combined.

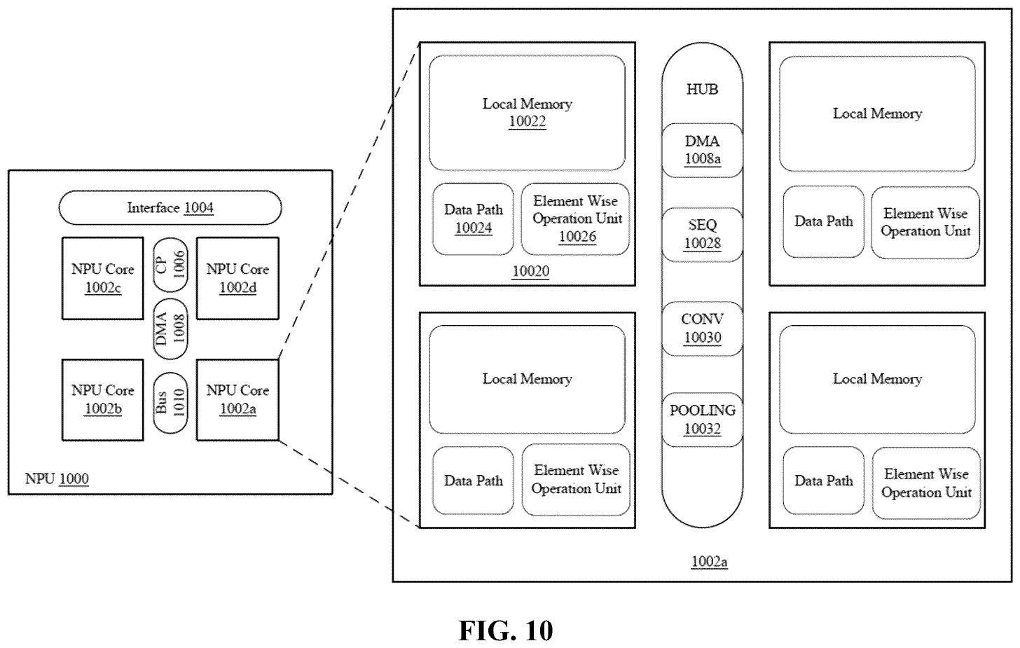

The methods shown in FIG. 7 and FIG. 9 can be performed using one or more neural processing units (“NPUs”). FIG. 10 shows an exemplary neural processing unit 1000, according to some embodiments of the present disclosure. As shown in FIG. 10, NPU 1000 can include at least one core 1002 (e.g., 1002a, 1002b, 1002c, and 1002d), an interface 1004, a command parser (CP) 1006, a direct memory access (DMA) unit 1008, and the like. It is appreciated that NPU 1000 can also include a bus 1010, a global memory (not shown), and the like. It is appreciated that the neural networks and the methods described in various embodiments of the present disclosure can be performed using NPU 1000 shown in FIG. 10. For example, in some embodiments, NPU 1000 can be used to perform the methods shown in FIG. 7. In some embodiments, NPU 1000 may include multiple machine analysis models M1-Mn in FIG. 8.

Interface 1004 can provide communication between NPU 1000 and outside devices. For example, interface 1004 can include a peripheral component interconnect express (PCI-E) interface, which provides connection with a host unit (not shown in FIG. 10). Interface 1004 can also include at least one of a universal serial bus (USB), a joint test action group (JTAG) interface, a TUN/TAP interface, and the like.

CP 1006 can interact with the host unit under the supervision of kernel mode driver (KMD) and pass neural network task, the pertinent commands or instruction and data to each NPU core 1002. CP 1006 can include circuitry configured to perform the interaction with the host unit and passing of neural network task, the pertinent commands or instruction and data to each NPU core 1002. In some embodiments, CP 1006 can receive a DMA command from the host unit, and load instructions for a neural network (e.g., a sequence of instructions for the neural network generated by a compiler in the host unit), weights or scale/bias constant of the neural network to an NPU core 1002 according to the DMA command. For example, CP 1006 can load instructions for neural network from an external memory to an instruction buffer of the NPU core 1002, weights to a local memory 10022 of the NPU core 1002, or scale/bias constant to a constant buffer of the NPU core 1002, according to the DMA command. In some embodiments, CP 1006 can work with a host unit or KMD to distribute neural network tasks (e.g., recognition of an image, including data for the image) to NPU core 1002. For example, the host unit or KMD can send a neural network task to a queue for an NPU core 1002 to which the neural network task is assigned, and CP 1006 can distribute the neural network task to the NPU core 1002. In some embodiments, when neural network task is finished on NPU core 1002 (e.g., NPU core 1002 can send a “compute done” message to CP 1006), CP 1006 can notify the host unit or KMD. A new neural network task can be assigned to the NPU core 1002 by the host unit or KMD.

DMA unit 1008 can assist with transferring data between components of NPU 1000. DMA unit 1008 can include circuitry configured to perform transfer of data or commands. For example, DMA unit 1008 can assist with transferring data between multiple NPU cores (e.g., cores 1002a-1002d) or within each NPU core. DMA unit 1008 can also allow off-chip devices to access both on-chip and off-chip memory via interface 1004 without causing an interruption. For example, DMA unit 1008 can load data or instructions into local memory of NPU cores. Thus, DMA unit 1008 can also generate memory addresses and initiate memory read or write cycles. DMA unit 1008 also can contain several hardware registers that can be written and read by the one or more processors, including a memory address register, a byte-count register, one or more control registers, and other types of registers. These registers can specify some combination of the source, the destination, the direction of the transfer (reading from the input/output (I/O) device or writing to the I/O device), the size of the transfer unit, or the number of bytes to transfer in one burst. It is appreciated that each NPU core (e.g., core 1002a) can include a sub DMA unit, which can be used to transfer data within the NPU core.

DMA unit 1008 can also move block data among NPU cores via bus 1010. While a single NPU core is capable of handling a typical inference task (e.g., ResNet50 v1), NPU cores can also work together via the bus to take on large and complex tasks (e.g., RestNet101, Mask R-CNN, and the like).

Bus 1010 can provide high speed cross NPU cores communication. Bus 1010 also connects the NPU cores with other units, such as the off-chip memory or peripherals.

Core 1002 (e.g., core 1002a) can include one or more processing units configured to perform one or more operations (e.g., multiplication, addition, multiply-accumulate, element-wise operation, etc.) based on commands received from, e.g., CP 1006. For example, core 1002 can receive a neural network task, instructions and data (e.g., weights or scale/bias constant of a neural network) from CP 1006, and execute the instructions using the data. In some embodiments, when NPU core 1002 finishes neural network task, it can notify CP 1006. For example, NPU core 1002 can send a “compute done” message to CP 1006. As shown in FIG. 10, core 1002a can include at least one operation unit 10020, a sequencer 10028, a convolution unit 10030, a pooling unit 10032, and a DMA unit 1008a, which can be connected via a data fabric and arbitration sub-system (also referred to as a HUB unit). In some embodiments, the HUB unit can include circuitry configured to provide convolution data and pooling data associated with the neural network task to convolution unit 10030 and pooling unit 10032, respectively.

Operation unit 10020 can include circuitry configured to perform operations on received data (e.g., matrices). In some embodiments, each operation unit 10020 can further include a local memory 10022, a matrix multiplication data path (DP) 10024, and an in-lined element-wise operation (EWOP) unit 10026. Local memory 10022 can provide storage space with fast read/write speed. To reduce possible interaction with a global memory, storage space of local memory 10022 can be 180 megabytes (MB) and above. With the massive storage space, most of data access can be performed within core 1002, reducing the latency caused by data access. DP 10024 can include circuitry configured to perform matrix multiplication (e.g., dot production), and EWOP unit 10026 can include circuitry configured perform element-wise operation on received data (e.g., vector-vector multiplication). It is appreciated that, though FIG. 10 shows four operation units 10020, core 1002a can include more or less operation units 10020.

Sequencer 10028 can be coupled with the instruction buffer and include circuitry configured to retrieve instructions (or commands) and distribute the instructions to components of e.g., core 1002. For example, sequencer 10028 can include circuitry configured to distribute convolution instructions to convolution unit 10030 to perform convolution operations or distribute pooling instructions to pooling unit 10032 to perform pooling operations. In some embodiments, sequencer 10028 can include circuitry configured to modify the pertinent instructions stored in the instruction buffer of each NPU core 1002, so that NPU cores 1002 can work in parallel as much as possible. Sequencer 10028 can also include circuitry configured to monitor execution of a neural network task and parallelize sub-tasks of the neural network task to improve efficiency of the execution.

Convolution unit 10030 can be coupled with sequencer 10028 and one or more operation units 10020 and include circuitry configured to instruct the one or more operation units 10020 to perform convolution operations. In some embodiments, convolution unit 10030 can send commands to local memory 10022 to send activation data and weight data to data path 10024 for performing convolution operations.

Pooling unit 10032 can further include an interpolation unit, a pooling data path, and the like, and include circuitry configured to perform pooling operations. For example, the interpolation unit can include circuitry configured to interpolate pooling data. The pooling data path can include circuitry configured to perform a pooling operation on the interpolated pooling data.

DMA unit 1008a can be part of DMA unit 1008 or an independent unit of each core. DMA unit 1008a includes circuitry configured to transfer data or commands. Commands can also be distributed to DMA unit 1008a to instruct DMA unit 1008a to load instructions/commands or data from a local memory (e.g., local memory 10022 of FIG. 10) into corresponding units. The loaded instructions/commands or data may then be distributed to each processing unit assigned with the corresponding task, and the one or more processing units may process these instructions/commands.

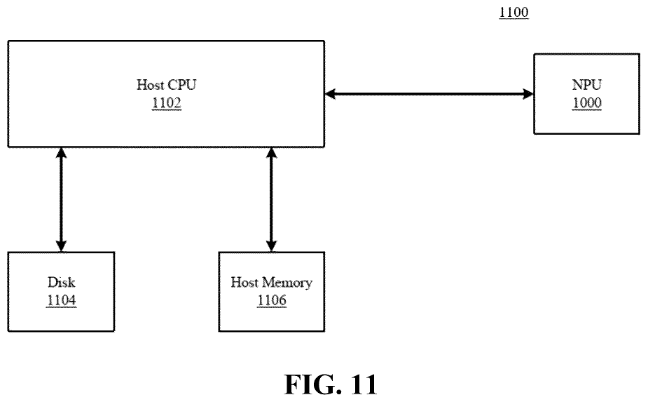

FIG. 11 shows an exemplary machine learning system 1100, according to some embodiments of the present disclosure. As shown in FIG. 11, machine learning system 1100 may include a host CPU 1102, a disk 1104, a host memory 1106, and a neural network processing unit (NPU) 1000. In some embodiments, host memory 1106 may be an integral memory or an external memory associated with host CPU 1102. Host memory 1106 may be a local or a global memory. In some embodiments, disk 1104 may comprise an external memory configured to provide additional memory for host CPU 1102. It is appreciated that the neural networks and the methods described above in various embodiments of the present disclosure can be performed using the machine learning system 1100 shown in FIG. 11.

Host CPU 1102 (e.g., an X86 or ARM central processing unit) can be coupled with host memory 1106 and disk 1104, configured to process general instructions. NPU 1000 may be connected to host CPU 1102 through a peripheral interface (e.g., interface 1004). As referred to herein, a neural network processing unit (e.g., NPU 1000) may be a computing device for accelerating neural network inference tasks. In some embodiments, NPU 1000 may be configured to be used as a co-processor of host CPU 1102.

In some embodiments, Host CPU 1102 is configured to perform encoding and decoding processes 300A, 300B, 400A, or 400B. NPU is configured to perform convolutions (e.g., down-sampling 810 and up-sampling 820) and machine analysis (e.g., machine analysis models M1-Mn).

In some embodiments, a compiler may be on a host unit (e.g., host CPU 1102 or host memory 1106 of FIG. 11) or NPU 1000, configured to push one or more commands to NPU 1000. The compiler is a program or computer software that transforms computer codes written in one programming language into instructions for NPU 1000 to create an executable program. In machine learning applications, a compiler can perform a variety of operations, for example, pre-processing, lexical analysis, parsing, semantic analysis, conversion of input programs to an intermediate representation, initialization of a neural network, code optimization, and code generation, or combinations thereof. For example, in machine learning system 1100, the compiler can compile a neural network to generate static parameters, e.g., connections among neurons and weights of the neurons.

As discussed above, these instructions or commands can be further loaded by CP 1006 of NPU 1000, temporarily stored in an instruction buffer of NPU 1000, and distributed (e.g., by sequencer 10028) to processing units of NPU 1000 (e.g., convolution unit 10030, pooling unit 10032, and DMA unit 1008a) accordingly.

It is appreciated that the first few instructions received by the NPU cores may instruct the NPU cores to load/store data from host memory 1106 into one or more local memories (e.g., local memory 10022 of FIG. 10) of the NPU core. Each NPU core may then initiate the instruction pipeline, which involves fetching the instruction (e.g., via a sequencer) from the instruction buffer, decoding the instruction (e.g., via a DMA unit) and generating local memory addresses (e.g., corresponding to an operand), reading the source data, executing or loading/storing operations, and then writing back results.

Accordingly, the machine learning system 1100 may provide a system for image or video processing. The host memory 1106 stores a set of instructions, and the host CPU 1102 is configured to execute the set of instructions to cause the system to perform the resampling and encoding/decoding process. For example, during the encoding process, the host CPU 1102 may execute the set of instructions to receive an input image, down-sample, by the down-sampling module, the input image to generate a down-sampled image data, and compress the down-sampled image data to obtain a quantized and compressed bitstream. The down-sampling module may be trained based on the loss function associated with analysis models during the training stage with the methods discussed above using training image data. In some embodiments, the host CPU 1102 may execute the set of instructions to select a resampling factor based on parameters of the input image before down-sampling the input image based on the resampling factor, and provide the bitstream having an index representing the resampling factor and coded data obtained by compressing the down-sampled image data. Accordingly, when the bitstream is transmitted to the decoder, the decoder can decode the bitstream and perform the up-sampling based on the same resampling factor. As discussed above, the parameters of the input image for the selection of the resampling factor may include the width and the height of the input image, and the area of object regions calculated by the instance segmentation network performing the instance segmentation to the input image.

Similarly, during the decoding process, the host CPU 1102 may execute the set of instructions to receive a bitstream including coded data associated with an input image, decode the bitstream to obtain a reconstructed image data, and up-sample, by an up-sampling module, the reconstructed image data to generate an up-sampled image data corresponding to the input image. The up-sampling module may be trained based on the loss function associated with analysis models during the training stage with the methods discussed above using training image data. In some embodiments, the bitstream may include both an index representing a resampling factor selected based on parameters of the input image, and the coded data associated with the input image. Accordingly, the host CPU 1102 may execute the set of instructions to up-sample the reconstructed image data based on the resampling factor to generate the up-sampled image data.

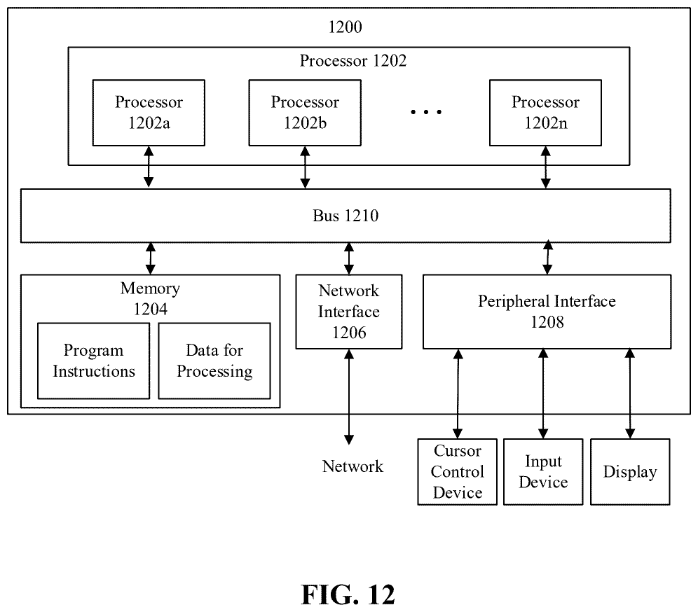

FIG. 12 is a block diagram of an example apparatus 1200 for processing image data, consistent with embodiments of the disclosure. For example, apparatus 1200 may be a processor, an encoder, or a decoder. As shown in FIG. 12, apparatus 1200 can include processor 1202. When processor 1202 executes instructions described herein, apparatus 1200 can become a specialized machine for video encoding or decoding. Processor 1202 can be any type of circuitry capable of manipulating or processing information. For example, processor 1202 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 1202 can also be a set of processors grouped as a single logical component. For example, as shown in FIG. 12, processor 1202 can include multiple processors, including processor 1202a, processor 1202b, and processor 1202n.

Apparatus 1200 can also include memory 1204 configured to store data (e.g., a set of instructions, computer codes, intermediate data, or the like). For example, as shown in FIG. 12, the stored data can include program instructions (e.g., program instructions for implementing the methods described in the present disclosure. Processor 1202 can access the program instructions and data for processing (e.g., via bus 1210), and execute the program instructions to perform an operation or manipulation on the data for processing. Memory 1204 can include a high-speed random-access storage device or a non-volatile storage device. In some embodiments, memory 1204 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 1204 can also be a group of memories (not shown in FIG. 12) grouped as a single logical component.

Bus 1210 can be a communication device that transfers data between components inside apparatus 1200, such as an internal bus (e.g., a CPU-memory bus), an external bus (e.g., a universal serial bus port, a peripheral component interconnect express port), or the like.

For ease of explanation without causing ambiguity, processor 1202 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 1200.

Apparatus 1200 can further include network interface 1206 to provide wired or wireless communication with a network (e.g., the Internet, an intranet, a local area network, a mobile communications network, or the like). In some embodiments, network interface 1206 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, apparatus 1200 can further include peripheral interface 1208 to provide a connection to one or more peripheral devices. As shown in FIG. 12, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs consistent with the present disclosure can be implemented as any combination of any software or hardware modules in apparatus 1200. For example, some or all stages of the disclosed methods can be implemented as one or more software modules of apparatus 1200, such as program instructions that can be loaded into memory 1204. For another example, some or all stages of the disclosed methods can be implemented as one or more hardware modules of apparatus 1200, such as a specialized data processing circuit (e.g., an FPGA, an ASIC, an NPU, or the like).

In some embodiments, a non-transitory computer-readable storage medium including instructions is also provided, and the instructions may be executed by a device (such as the disclosed codec, the processor), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, or a memory.

It is noted that the embodiments described in the present disclosure can be freely combined or used separately.

The embodiments may further be described using the following clauses:
1. A video processing method, comprising:
   receiving an input picture;
   generating a multi-scale attention mask for the input picture; and
   training a resampling module using the multi-scale attention mask, wherein the trained resampling module is used to process the input picture.
2. The method according to clause 1, wherein generating a multi-scale attention mask for the input picture further comprises:
   detecting one or more objects the input picture;
   determining one or more values representing importance weights based on the one or more detected objects; and
   generating the multi-scale attention mask with the one or more values.
3. The method according to clause 2, wherein the multi-scale attention mask has a same resolution as a resolution of the input picture.
4. The method according to clause 2, wherein the one or more values are determined based on sizes of the one or more detected objects.
5. The method according to clause 1, wherein the trained resampling module includes a down-sampling module and an up-sampling module, wherein the input picture is processed based on:
   down-sampling the input picture using the down-sampling module to obtain a down-sampled picture;
   encoding and decoding the down-sampled picture to obtain a reconstructed picture; and
   up-sampling the reconstructed picture using the up-sampling module to obtain an output picture.
6. The method according to clause 5, further comprising:
   determining a multi-scale loss function based on the multi-scale attention mask.
7. The method according to clause 6, wherein the multi-scale loss function is

$${L ( x , {x}_{U} , {M}_{s} ) = {‖ {x}_{U} - x ‖}_{2}^{2} + ‖ {〚 {M}_{s} ( x 〛}_{U} - x ) ‖}_{2}^{2} + {\sum }_{i}^{n} {{w}_{f , i} 〚 ( L 〛}_{f , i} ( x , {x}_{U} , {w}_{f , i} ) + {L}_{f , i , {M}_{s}} ( x , {x}_{U} , {M}_{s} , {w}_{f , i} ) ) ;$$

where Mₛ is the multi-scale attention mask, {w_{f,i}} are weights of feature map distortion from various machine analysis models, x is the input picture, x_{U} is an output picture after resampling.
8. An apparatus for video processing, comprising:
   a memory configured to store instructions; and
   one or more processors configured to execute the instructions to cause the apparatus to perform operations comprising:
      receiving an input picture;
      generating a multi-scale attention mask for the input picture; and
      training a resampling module using the multi-scale attention mask, wherein the trained resampling module is used to process the input picture.
9. The apparatus according to according to clause 8, wherein generating a multi-scale attention mask for the input picture further comprises:
   detecting one or more objects the input picture;
   determining one or more values representing importance weights based on the one or more detected objects; and
   generating the multi-scale attention mask with the one or more values.
10. The apparatus according to clause 9, wherein the multi-scale attention mask has a same resolution as a resolution of the input picture.
11. The apparatus according to clause 9, wherein the one or more values are determined based on sizes of the one or more detected objects.
12. The apparatus according to clause 8, wherein the trained resampling module includes a down-sampling module and an up-sampling module, wherein the input picture is processed based on:
   down-sampling the input picture using the down-sampling module to obtain a down-sampled picture;
   encoding and decoding the down-sampled picture to obtain a reconstructed picture; and
   up-sampling the reconstructed picture using the up-sampling module to obtain an output picture.
13. The apparatus according to clause 12, wherein the operations further comprise:
   determining a multi-scale loss function based on the multi-scale attention mask.
14. The apparatus according to clause 13, wherein the multi-scale loss function is

$${L ( x , {x}_{U} , {M}_{s} ) = {‖ {x}_{U} - x ‖}_{2}^{2} + ‖ {〚 {M}_{s} ( x 〛}_{U} - x ) ‖}_{2}^{2} + {\sum }_{i}^{n} {{w}_{f , i} 〚 ( L 〛}_{f , i} ( x , {x}_{U} , {w}_{f , i} ) + {L}_{f , i , {M}_{s}} ( x , {x}_{U} , {M}_{s} , {w}_{f , i} ) ) ;$$

where Mₛ is the multi-scale attention mask, {w_{f,i}} are weights of feature map distortion from various machine analysis models, x is the input picture, x_{U} is an output picture after resampling.
15. A non-transitory computer readable medium that stores a set of instructions that is executable by one or more processors of an apparatus to cause the apparatus to perform operations comprising:
   receiving an input picture;
   generating a multi-scale attention mask for the input picture; and
   training a resampling module using the multi-scale attention mask, wherein the trained resampling module is used to process the input picture.
16. The non-transitory computer readable medium according to clause 15, wherein generating a multi-scale attention mask for the input picture further comprises:
   detecting one or more objects the input picture;
   determining one or more values representing importance weights based on the one or more detected objects; and
   generating the multi-scale attention mask with the one or more values.
17. The non-transitory computer readable medium according to clause 16, wherein the multi-scale attention mask has a same resolution as a resolution of the input picture.
18. The non-transitory computer readable medium according to clause 16, wherein the one or more values are determined based on sizes of the one or more detected objects.
19. The non-transitory computer readable medium according to clause 15, wherein the trained resampling module includes a down-sampling module and an up-sampling module, wherein the input picture is processed based on:
   down-sampling the input picture using the down-sampling module to obtain a down-sampled picture;
   encoding and decoding the down-sampled picture to obtain a reconstructed picture; and
   up-sampling the reconstructed picture using the up-sampling module to obtain an output picture.
20. The non-transitory computer readable medium according to clause 19, wherein the operations further comprise:
   determining a multi-scale loss function based on the multi-scale attention mask.
21. The non-transitory computer readable medium according to clause 20, wherein the

$${multi - scale loss function is L ( x , {x}_{U} , {M}_{s} ) = {‖ {x}_{U} - x ‖}_{2}^{2} + ‖ {〚 {M}_{s} ( x 〛}_{U} - x ) ‖}_{2}^{2} + {\sum }_{i}^{n} {{w}_{f , i} 〚 ( L 〛}_{f , i} ( x , {x}_{U} , {w}_{f , i} ) + {L}_{f , i , {M}_{s}} ( x , {x}_{U} , {M}_{s} , {w}_{f , i} ) ) ;$$

where Mₛ is the multi-scale attention mask, {w_{f,i}} are weights of feature map distortion from various machine analysis models, x is the input picture, x_{U} is an output picture after resampling.
22. A video processing method, comprising:
   receiving an input picture;
   determining whether a resolution of the input picture is smaller than a preset threshold; and
   when the resolution of the input picture is smaller than the preset threshold, performing up-sampling on the input picture.
23. The method according to clause 22, wherein performing up-sampling on the input picture is performing up-sampling on the input picture before encoding.
24. The method according to clause 22, wherein performing up-sampling on the input picture is performing up-sampling on a reconstructed picture of the input picture after decoding.
25. The method according to clause 22, further comprising:
   determining a resampling ratio based on the resolution of the input picture.
26. An apparatus for video processing, comprising:
   a memory configured to store instructions; and
   one or more processors configured to execute the instructions to cause the apparatus to perform operations comprising:
      receiving an input picture;
      determining whether a resolution of the input picture is smaller than a preset threshold; and
      when the resolution of the input picture is smaller than the preset threshold, performing up-sampling on the input picture.
27. The apparatus according to clause 26, wherein performing up-sampling on the input picture is performing up-sampling on the input picture before encoding.
28. The apparatus according to clause 26, wherein performing up-sampling on the input picture is performing up-sampling on a reconstructed picture of the input picture after decoding.
29. The apparatus according to clause 26, wherein the operations further comprise:
   determining a resampling ratio based on the resolution of the input picture.
30. A non-transitory computer readable medium that stores a set of instructions that is executable by one or more processors of an apparatus to cause the apparatus to perform operations comprising:
   receiving an input picture;
   determining whether a resolution of the input picture is smaller than a preset threshold; and
   when the resolution of the input picture is smaller than the preset threshold, performing up-sampling on the input picture.
31. The non-transitory computer readable medium according to clause 30, wherein performing up-sampling on the input picture is performing up-sampling on the input picture before encoding.
32. The non-transitory computer readable medium according to clause 30, wherein performing up-sampling on the input picture is performing up-sampling on a reconstructed picture of the input picture after decoding.
33. The non-transitory computer readable medium according to clause 30, wherein the operations further comprise:
   determining a resampling ratio based on the resolution of the input picture.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A video processing method, comprising:
receiving an input picture;
generating a multi-scale attention mask for the input picture; and
training a resampling module using the multi-scale attention mask, wherein the trained resampling module is used to process the input picture.

2. The method according to claim 1, wherein generating a multi-scale attention mask for the input picture further comprises:
detecting one or more objects the input picture;
determining one or more values representing importance weights based on the one or more detected objects; and
generating the multi-scale attention mask with the one or more values.

3. The method according to claim 2, wherein the multi-scale attention mask has a same resolution as a resolution of the input picture.

4. The method according to claim 2, wherein the one or more values are determined based on sizes of the one or more detected objects.

5. The method according to claim 1, wherein the trained resampling module includes a down-sampling module and an up-sampling module, wherein the input picture is processed based on:
down-sampling the input picture using the down-sampling module to obtain a down-sampled picture;
encoding and decoding the down-sampled picture to obtain a reconstructed picture; and
up-sampling the reconstructed picture using the up-sampling module to obtain an output picture.

6. The method according to claim 5, further comprising:
determining a multi-scale loss function based on the multi-scale attention mask.

7. The method according to claim 6, wherein the multi-scale loss function is
$${L ( x , {x}_{U} , {M}_{s} ) = {‖ {x}_{U} - x ‖}_{2}^{2} + ‖ {〚 {M}_{s} ( x 〛}_{U} - x ) ‖}_{2}^{2} + {\sum }_{i}^{n} {{w}_{f , i} 〚 ( L 〛}_{f , i} ( x , {x}_{U} , {w}_{f , i} ) + {L}_{f , i , {M}_{s}} ( x , {x}_{U} , {M}_{s} , {w}_{f , i} ) ) ;$$
where Mₛ is the multi-scale attention mask, {w_{f,i}} are weights of feature map distortion from various machine analysis models, x is the input picture, x_{U} is an output picture after resampling.

8. An apparatus for video processing, comprising:
a memory configured to store instructions; and
one or more processors configured to execute the instructions to cause the apparatus to perform operations comprising:
receiving an input picture;
generating a multi-scale attention mask for the input picture; and
training a resampling module using the multi-scale attention mask, wherein the trained resampling module is used to process the input picture.

9. The apparatus according to according to claim 8, wherein generating a multi-scale attention mask for the input picture further comprises:
detecting one or more objects the input picture;
determining one or more values representing importance weights based on the one or more detected objects; and
generating the multi-scale attention mask with the one or more values.

10. The apparatus according to claim 9, wherein the multi-scale attention mask has a same resolution as a resolution of the input picture.

11. The apparatus according to claim 9, wherein the one or more values are determined based on sizes of the one or more detected objects.

12. The apparatus according to claim 8, wherein the trained resampling module includes a down-sampling module and an up-sampling module, wherein the input picture is processed based on:
down-sampling the input picture using the down-sampling module to obtain a down-sampled picture;
encoding and decoding the down-sampled picture to obtain a reconstructed picture; and
up-sampling the reconstructed picture using the up-sampling module to obtain an output picture.

13. The apparatus according to claim 12, wherein the operations further comprise:
determining a multi-scale loss function based on the multi-scale attention mask.

14. The apparatus according to claim 13, wherein the multi-scale loss function is
$${L ( x , {x}_{U} , {M}_{s} ) = {‖ {x}_{U} - x ‖}_{2}^{2} + ‖ {〚 {M}_{s} ( x 〛}_{U} - x ) ‖}_{2}^{2} + {\sum }_{i}^{n} {{w}_{f , i} 〚 ( L 〛}_{f , i} ( x , {x}_{U} , {w}_{f , i} ) + {L}_{f , i , {M}_{s}} ( x , {x}_{U} , {M}_{s} , {w}_{f , i} ) ) ;$$
where Mₛ is the multi-scale attention mask, {w_{f,i}} are weights of feature map distortion from various machine analysis models, x is the input picture, x_{U} is an output picture after resampling.

15. A non-transitory computer readable medium that stores a set of instructions that is executable by one or more processors of an apparatus to cause the apparatus to perform operations comprising:
receiving an input picture;
generating a multi-scale attention mask for the input picture; and
training a resampling module using the multi-scale attention mask, wherein the trained resampling module is used to process the input picture.

16. The non-transitory computer readable medium according to claim 15, wherein generating a multi-scale attention mask for the input picture further comprises:
detecting one or more objects the input picture;
determining one or more values representing importance weights based on the one or more detected objects; and
generating the multi-scale attention mask with the one or more values.

17. The non-transitory computer readable medium according to claim 16, wherein the multi-scale attention mask has a same resolution as a resolution of the input picture.

18. The non-transitory computer readable medium according to claim 16, wherein the one or more values are determined based on sizes of the one or more detected objects.

19. The non-transitory computer readable medium according to claim 15, wherein the trained resampling module includes a down-sampling module and an up-sampling module, wherein the input picture is processed based on:
down-sampling the input picture using the down-sampling module to obtain a down-sampled picture;
encoding and decoding the down-sampled picture to obtain a reconstructed picture; and
up-sampling the reconstructed picture using the up-sampling module to obtain an output picture.

20. The non-transitory computer readable medium according to claim 19, wherein the operations further comprise:
determining a multi-scale loss function based on the multi-scale attention mask.
